(19) United States
(12) Patent Application Publication
(10) Pub. No.: US 2012/0324572 A1
(43) Pub. Date: Dec. 20, 2012

(54) SYSTEMS AND METHODS THAT PERFORM APPLICATION REQUEST THROTTLING IN A DISTRIBUTED COMPUTING ENVIRONMENT

(75) Inventors: David Gordon, Montreal (CA); Makan Pourzandi, Montreal (CA)

(73) Assignee: TELEFONAKTIEBOLAGET L M ERICSSON (PUBL), Stockholm (SE)

(21) Appl. No.: 13/162,349

(22) Filed: Jun. 16, 2011

(51) Int. Cl. G06F 21/00

(52) U.S. Cl. 726/22

(57) ABSTRACT

Methods of managing network traffic in a distributed computing environment include segmenting a plurality of virtual hosts into sub-groups. A first security agent monitors first communications of virtual hosts within a first sub-group of virtual hosts, and a second security agent monitors second communications of virtual hosts within a second sub-group of virtual hosts. Information regarding the first communications and the second communications is collected from the security agents and analyzed to detect a denial of service attack. A defense mechanism is initiated in response to detecting the denial of service attack.

### FIELD

The present invention relates to computer network security, and in particular relates to systems and methods for detecting and countering security threats in a distributed computing environment.

### BACKGROUND

A Denial of Service (DoS) attack occurs when a malicious computer system attempts to overwhelm the resources of a target system, making the target system effectively unavailable for use by legitimate clients. For example, a DoS attack may attempt to overwhelm the bandwidth of a web server by sending multiple illegitimate requests to the web server in a short period of time. Because the network address of a web server may be available to anyone, a DoS attack may be mounted without having to first compromise security measures, such as passwords, encryption keys, and the like.

In a Distributed Denial of Service (DDoS) attack, multiple attacking systems attempt to overwhelm the resources of a targeted system in a coordinated or uncoordinated manner. DDoS attacks typically target the most obvious bottleneck, which is the bandwidth of the server. In many cases, the attacking systems have themselves been compromised and are under the control of one or more malicious systems through use of malicious computer software, such as a trojan horse, virus, worm, zombie, etc.

As with a DoS attack, a DDoS attack attempts to make a resource unavailable to legitimate users by exhausting the target or underlying resources either through sheer number of illegitimate requests or through the exploitation of a particular weakness in the target system. Thus, two kinds of attacks are prevalent, namely a flooding attack in which a large number of illegitimate requests are sent, and a low-level attack in which significantly fewer requests are sent, but those requests target a weakness in the particular protocol or application used by the target system.

“Cloud computing” has introduced a new business model for the provision of computing services to clients. “Cloud computing” generally refers to a distributed computing environment for providing computing resources to clients on behalf of service providers, in which virtual hosts are made visible to the clients while the underlying physical configuration of the network is hidden from the clients.

The distributed computing environment may include physical resources, such as processors, databases, storage devices, routers, etc., that are hidden from clients outside the distributed computing environment. One or more network access points may be provided by which clients can physically access the distributed computing environment. However, services are provided by one or more virtual hosts that are instantiated on the physical resources in the distributed computing environment and that are accessible by the clients through the network access points.

A service provider, such as an online retailer, game provider, etc., may purchase computing resources from an infrastructure provider that operates the infrastructure that makes up the “cloud.” The infrastructure provider configures the physical resources within the cloud to provide virtual hosts that provide services of the service provider to clients (who, in turn, may be customers of the service provider). Virtual hosts that provide services for a particular service provider can be organized into a virtual service domain for ease of management. Virtual hosts can be added, deleted or moved within the computing environment as desired to accommodate varying levels of demand for services provided by the virtual hosts.

Accordingly, cloud computing can provide a flexible, scalable model in which physical resources can be dynamically allocated to meet varying resource demands while providing a consistent interface to client applications.

Given the ready scalability of a cloud computing environment, the resources available to a service provider can be arbitrary, in that the resources dedicated to a particular virtual service domain can be increased in response to increases in demand from clients. For example, new virtual hosts can be instantiated in response to an increase in the number of client requests for a particular type of service.

By nature, the cloud infrastructure is different from the typical enterprise computing environment, in that the cloud environment is open to the external world, and the nature of the applications running inside the cloud is typically unknown to the infrastructure provider. In addition, a cloud may support a variety of protocols and traffic behavior, depending on the nature of different applications run by different service providers in the cloud.

The conventional DDoS attack model is an attack from multiple sources towards a single or few targets. For targets operating in a cloud model, the DDoS attack model is an attack from multiple sources to multiple targets.

A significant amount of effort has been undertaken in an attempt to detect and counter DDoS attacks. U.S. Pat. No. 7,032,048 describes distributed content throttling. The distributed aspect consists in implementing the method and system on every web server in the web farm, as content refers to web requests. There is no central monitoring of the state of the web farm as a whole.

U.S. Publication No. 2010/0235632 describes methods for combating denial of service attacks by using crypto challenges and specific HTTP types of defense, but does not do so in a distributed environment.

U.S. Publication No. 2010/0082513 describes a system and method for discovery and classification of DDoS attacks in distributed systems. However, this reference discloses a hierarchy of agents wherein there is one agent per node, and wherein each agent collects information and sends it to its superior in the hierarchy. The attacks that are monitored are attacks on one node at a time.

U.S. Publication No. 2008/0034425 describes a system and method for protecting web applications from attacks.

An algorithm that performs congestion control, which may be used to defeat a denial of service attack, is described in J. G. Alfaro, F. Cuppens, and N. Cuppens-Boulahia, “Analysis of Policy Anomalies on Distributed Network Security Setups,” Lecture Notes in Computer Science, Volume 4189/2006, pp. 496-511 (2006). The algorithm is not adapted to a distributed environment, however.

Other techniques for combating DoS attacks are described in E. Al-Shaer, H. Hamed, R. Boutaba, M. Hasan, “Conflict Classification and Analysis of Distributed Firewall Policies,” IEEE Journal on Selected Areas in Communications, Vol. 23, pp. 2069-2084 (2005), M. G. Gouda, A. X. Liu, M. Jafry, “Verification of Distributed Firewalls,” Proceedings of the IEEE Global Communications Conference (GLOBECOM) (2008), and Ratul Mahajan, Steven M. Bellovin, Sally Floyd, John Ioannidis, Vern Paxson, Scott Shenker, “Aggregate congestion control,” Computer Communication Review 32(1): 69 (2002).

In these papers, the authors formalize different firewalling rules for individual and distributed firewalls. They study how to detect anomalies in different firewall rule sets. Mainly, firewalling rules are static. They concern an action on one or several IP addresses. In this perspective, there are no interactions between different firewalls, as for us there is the necessity of different security monitoring centers to interact with each other to make a decision through collaboration.

### SUMMARY

Some embodiments provide methods of managing network traffic in a distributed computing environment that provides virtual computing services to clients outside the distributed computing environment. The distributed computing environment includes a plurality of physical resources, a plurality of network access points coupled to the plurality of physical resources by which clients can access the distributed computing environment, and a plurality of virtual hosts that are instantiated on the physical resources in the distributed computing environment and that are accessible by the clients through the plurality of network access points.

The methods include segmenting the plurality of virtual hosts into sub-groups of one or more virtual hosts and providing a plurality of security agents within the distributed computing environment. Each of the plurality of security agents is associated with a respective sub-group of virtual hosts. A first security agent monitors first communications of virtual hosts within a first sub-group of virtual hosts associated with the first security agent, and a second security agent monitors second communications of virtual hosts within a second sub-group of virtual hosts associated with the second security agent.

The methods further include collecting information regarding the first communications and the second communications, analyzing the collected information to detect a denial of service attack, and in response to detecting the denial of service attack, initiating a defense mechanism to counteract the denial of service attack.

Monitoring communications of virtual hosts within the first and second sub-groups includes monitoring at least one of number of service requests received from particular clients, number of abnormal requests received by virtual hosts, size of requests received by the virtual hosts, size of packets received by virtual hosts, frequency of requests received by virtual hosts, and bandwidth used by virtual hosts.

The methods may further include generating a first data structure at the first security agent in response to monitoring the first communications, generating a second data structure at the second security agent in response to monitoring the second communications, and combining the first and second data structures to form a combined data structure. Analyzing the collected information to detect the denial of service attack includes analyzing the combined data structure to detect the denial of service attack.

Combining the first and second data structures may be performed by a designated one of the first or second security agents or by each of the first and second security agents.

The methods may further include monitoring the first and second communications for a second communications characteristic that is different from a first communications characteristic, generating a third data structure at the first security agent in response to monitoring the first communications for the second communications characteristic, generating a fourth data structure at the second security agent in response to monitoring the second communications for the second communications characteristic, combining the third and fourth data structures to form a second combined data structure, and analyzing the second combined data structure to detect a second denial of service attack.

Initiating the defense mechanism may include determining an amount of network traffic that should be reduced in order to reduce an impact of the denial of service attack on the distributed computing system, identifying one or more nodes from a set of nodes with which the virtual hosts are communicating that can be eliminated to reduce network traffic by the determined amount, and instructing the network access points to block traffic from the identified one or more nodes.

The methods may further include identifying a suspicious request to one or more virtual hosts within the first sub-group of virtual hosts, and notifying the second security agent of the suspicious request in response to identifying the suspicious request.

The methods may further include identifying a plurality of suspicious requests to one or more virtual hosts within the sub-group of virtual hosts associated with the first one of the security agents, processing identities of clients from which the plurality of suspicious requests originated to form a suspicious identity signature, and transmitting the suspicious identity signature to the second security agent.

The suspicious identity signature may include a first suspicious identity signature, and the methods may further include receiving a second suspicious identity signature from the second security agent, comparing the first suspicious identity signature to the second suspicious identity signature, and resolving inconsistencies between the first suspicious identity signature and the second suspicious identity signature.

Processing the identities of clients from which the plurality of suspicious requests originated may include clustering the identities.

Processing the identities of clients from which the plurality of suspicious requests originated may includes sorting the identities into a tree of nodes.

The methods may further include determining an amount of network traffic that should be reduced in order to reduce an impact of the denial of service attack on the distributed computing system, identifying one or more nodes from the tree of nodes that can be eliminated to reduce the network traffic by the determined amount, and instructing the network access points to block traffic from the identified one or more nodes from the tree of nodes.

The plurality of hosts may include a virtual service domain within the distributed computing environment.

A security agent according to some embodiments includes a communications monitor configured to monitor communications of virtual hosts within an associated first sub-group of virtual hosts within a distributed computing environment, and a processor configured to generate a first data structure in response to the monitored communications, to receive a second data structure from another security agent, the second data structure generated in response to monitoring second communications of virtual hosts within a second sub-group of virtual hosts, to combine the first and second data structures, and to analyze the combined data structures to detect a denial of service attack.

The processor may be further configured to initiate a defense mechanism to counteract the denial of service attack in response to detecting the denial of service attack.

The communications monitor may be configured to monitor first and second characteristics of communications of virtual hosts within the first sub-group of virtual hosts, and the first data structure may be generated in response to the first characteristics of the communications. The processor may be further configured to generate a third data structure in response to the second characteristics of the communications.

The processor may be further configured to determine an amount of network traffic that should be reduced in order to reduce an impact of the denial of service attack on the distributed computing system, to identify one or more nodes from a set of nodes with which the virtual hosts are communicating that can be eliminated to reduce network traffic by the determined amount, and to instruct a network access point to block traffic from the identified one or more nodes.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic diagram that illustrates a cloud infrastructure configuration in accordance with some embodiments.

FIG. 2 is a schematic diagram that illustrates an arrangement of physical and virtual resources within a cloud infrastructure in accordance with some embodiments.

FIGS. 3-6 schematically illustrate collection of network monitoring data by a plurality of security agents according to some embodiments.

FIGS. 7 and 8 are flowcharts that illustrate operations in accordance with some embodiments.

FIG. 9 is a block diagram of a security agent in accordance with some embodiments.

### DETAILED DESCRIPTION OF EMBODIMENTS

Embodiments of the invention are directed to managing network traffic in a distributed computing environment that provides virtual computing services to clients outside the distributed computing environment. In general, the distributed computing environment may include a plurality of physical resources that are hidden from clients outside the distributed computing environment, a plurality of network access points coupled to the plurality of physical resources by which clients can access the distributed computing environment, and a plurality of virtual hosts that are instantiated on the physical resources in the distributed computing environment and that are accessible by the clients through the plurality of network access points.

The methods include segmenting the plurality of virtual hosts into sub-groups of one or more virtual hosts, and providing a plurality of security agents within the distributed computing environment, wherein each of the plurality of security agents is associated with a respective sub-group of virtual hosts. Each security agent monitors communications to/from virtual hosts within its respective sub-group. Information relating to communications to/from virtual hosts within the sub-group is collected and shared among the security agents. The shared information is harmonized, and suspicious requests that may indicate a denial of service attack are identified.

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

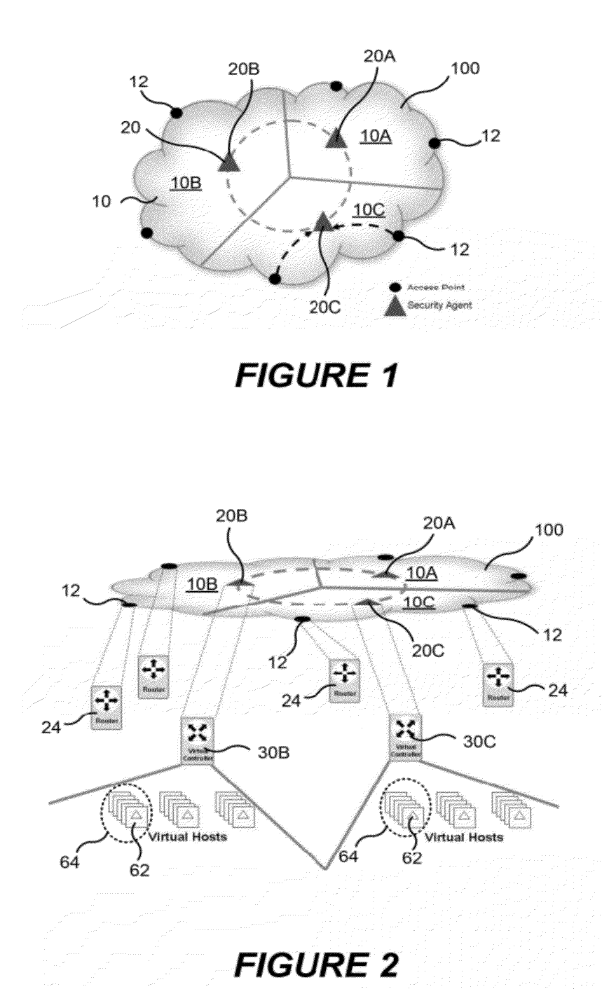

FIG. 1 illustrates a cloud computing environment in which embodiments of the invention may be employed. In particular, FIG. 1 illustrates a distributed computing environment, or cloud, 100, in which physical resources, such as processors, routers, storage devices, etc. are provided in a data communications network. Resources within the cloud 100 are accessible to client applications outside the cloud 100 via one or more access points 12, which may include edge routers, for example. The physical resources of the cloud 100 are divided into three segments 10A, 10B and 100. Although three segments are shown in FIG. 1, it will be appreciated that a cloud 100 can be segmented into any desired number of segments. Each segment 10A to 100 includes a corresponding security agent 20A, 20B, 20C, which is described in more detail below.

Each segment 10A to 100 has one or more access points 12 and is monitored by a security agent. The security agents 20A to 20C provide a cloud-level mechanism for monitoring and mitigation of security threats, such as DDoS attacks, within the cloud 100. The security agents 20A to 20C, which are distributed across the cloud 100, communicate together to coordinate information and response activities, providing cloud level awareness and intelligence to counter attacks that simultaneously target multiple hosts in the cloud 100.

FIG. 2 illustrates the implementation of virtual hosts within the cloud 100. In particular, FIG. 2 shows how the logical cloud architecture may map to the physical architecture in a simplified form. In particular, as shown in FIG. 2, the security agents (SA) 20B, 20C may be implemented as modules operating on virtual controllers 30B, 30C, which run on physical entities within the cloud 100 that control the operation of one or more virtual hosts (VH) 62. Virtual controllers are in charge of respective virtual machines and/or virtual service domains. The virtual hosts 62 provide services to clients outside the cloud 100. The access points 12 may include, for example, edge routers 24 that route external traffic to virtual controllers 30B, 30C within their respective segments 10A to 100 of the cloud 100.

The virtual hosts may be logically organized into virtual service domains (VSDs) 64 that may include virtual hosts organized according to some criterion. For example, a VSD 64 may include all virtual hosts 62 operated on behalf of a particular customer. It is possible for a VSD 64 to be divided into sub-VSDs serving different activities for the same customer. Other allocations of virtual hosts into VSDs are possible. Moreover, it is possible for a single VSD 64 to span multiple segments 10A to 100, and for hosts in a single VSD 64 to be hosted on different virtual controllers 30B, 30C.

Segmentation of the cloud 100 can be based on physical, logical service level and/or other criteria. In particular embodiments, segmentation of the cloud 100 may be based on the physical geographical layout of the cloud and/or on the different physical resource constraints of the cloud. As an example of physical segmentation, a cloud 100 may be segmented between datacenters located in different geographic regions, such as North America, Europe, and Asia. If such high level segments prove to be too large for a single security agent to handle, the segmentation can be further done in terms of resource constraints, such as network or CPU cycle bandwidth or even by customer. Thus, sub-segments can be defined to encompass certain access points or groups of virtual hosts/servers.

In order to defend multiple targets against attacks from multiple sources, some embodiments provide a cloud view of the monitoring and response activities. In some embodiments, there is one security agent per cloud segment. The security agent acts as a central node to consolidate security information for a particular segment of the cloud, and then coordinates with other security agents in other segments of the cloud 100.

The security agent may be implemented as a module that is hosted at the infrastructure level of the cloud 100. In particular, it may be desirable to host the security agent at the infrastructure level of the cloud 100, rather than on a virtual controller 30, because it is desirable for the security agent to be aware of the physical layout of the cloud. It must also be able to receive or to collect in a timely manner all the information about the requests received by different virtual hosts in its sector. Essentially, the security agent could be hosted on any node within its segment. However, in some embodiments, a security agent may be hosted on one of the controllers of virtual nodes within its segment.

The security agent is responsible for monitoring the application requests at the access points in his segment, communicating information with other security agents, and coordinate cloud-level security actions.

In some embodiments, security agents within the cloud 100 may provide collaborative monitoring services using an algorithm, such as the Aggregate Congestion Control (ACC) algorithm disclosed in Ratul Mahajan, Steven M. Bellovin, Sally Floyd, John Ioannidis, Vern Paxson, Scott Shenker, “Aggregate Congestion Control,” Computer Communication Review 32(1): 69 (2002). However, other detection algorithms could be used in some embodiments. The algorithm described herein is an adaptation of ACC to a collaborative security monitoring framework.

In some embodiments, different virtual hosts running in different segments of the cloud 100 may serve a single customer. All virtual hosts running within the cloud 100 for the account of a particular customer may be organized into a virtual service domain (VSD) as discussed above.

Embodiments of the invention may monitor and mitigate attacks for all virtual hosts belonging to a virtual service domain, even if the virtual hosts are distributed across different segments of the cloud 100. In contrast, in conventional enterprise security there is no concept of servers moving dynamically in the network. Generally, in the enterprise market, the servers are constrained to specific sub-networks which are set statically by the administrators.

As noted above, a variant of the ACC algorithm may be used to monitor different virtual hosts in a VSD 64 and use that information to detect and counteract attacks.

Monitoring the state of the cloud may be performed as follows. A security agent 20 can either monitor all requests sent to the virtual hosts 62 in a defined VSD 64, or a group of security agents 20 can monitor specific requests sent to the virtual hosts in the same VSD 64. Additionally, security agents 20 in a domain may also separate the task of monitoring sub-sections of virtual hosts. Through direct network traffic monitoring or through a trusted interaction with the virtual hosts 62, security agents 20 collect information regarding discarded or suspect requests.

Each security agent 20 may monitor some aspect of communications of virtual hosts 62 within its assigned sub-group. For example, a security agent may monitor any aspect or characteristic of communications of the virtual hosts that could help detect the presence of an attack, such as the number of service requests received from particular clients, the number of abnormal requests received by virtual hosts, the size of requests received by the virtual hosts, the size of packets received by virtual hosts, the frequency of requests received by virtual hosts, the bandwidth used by virtual hosts, a buffer fullness of the virtual hosts for a buffer that stores requests received by the virtual host, etc.

Different types of DDoS attacks may have different signatures, and it may be desirable to collect different types of information when attempting to identify particular types of DDoS attacks.

The information collected by a SA 20 may be stored in a data structure that is appropriate for the type of information being collected. For example, a SA 20 that is collecting information regarding the number of requests received from a particular client may store the information in a tree structure based on the IP address of the clients from whom requests are received. Other data structures may be used according to some embodiments, however.

Some important indicators of a DDoS attack are the existence of a number of requests that cannot be served by one or more virtual hosts 62, and the existence of a number of suspicious requests. In a cloud environment, customers benefit from the property of a cloud that allows the near instantaneous allocation of resources to serve requests that would otherwise be discarded (subject to service level agreements and costs). However, if a cloud-level DDoS defense only consider requests that are discarded due to congestion, the cloud may be in a scenario in which a significant number of physical resources have been allocated to a particular VSD to support a DDoS attack. This allocation of resources may jeopardize service to other customers. This particular scenario defines the need to monitor both suspicious requests and cloud-level behavior in response to incoming traffic to head off such an outcome. This will most likely be the case for entities that operate their own cloud internally, as generally one VSD will have access to all cloud resources.

On the other hand, cloud operators may also limit the number of resources that each customer may use, which is typically how outsourcing services are provided by cloud operators. When a customer nears their resource limit, overflow requests will be dropped. The interest of monitoring discarded requests at the cloud-level is to identify which section of the cloud is being affected to potentially redirect part of the overflow to sections of the cloud that are not affected. Although this type of intervention may be inherently part of the cloud offering, there is a need for a security agent 20 to act as a counter-balance to the regular load balancing functions that seek to minimize latency of response and resource usage. Thus, the security agent 20 may first attempt to filter out the bad traffic. Then, with the assumption that each section has limited resources dedicated to security functions, the security agent 20 may request to pro-actively redirect part of the traffic to other sections in order to use those resources for traffic filtering.

Identification and mitigation of DoS attacks may be coordinated by communication between security agents 20. The security agents 20 in a cloud 100 may communicate at run time with each other to exchange the information about discarded or suspect requests.

It is desirable for communications between security agents 20 to be secure. In some embodiments, secure connections may be established between security agents 20 using SSL/TLS based protocols. Should one security agent 20 become compromised, cloud-level DDoS defense would be compromised.

There are a host of existing protocols that can be used to implement communication between the SAs. For example, messaging between security agents 20 may be accomplished using Simple Object Access Protocol (SOAP). Security agent communications essentially include three types of messages: informational messages, defense coordination messages, and configuration messages.

Informational messages may carry information about the state of the current congestion and related usage statistics, and/or information about suspect behavior that needs to be monitored and correlated among security agents 20. Information about the state of a security agent's domain is relatively straightforward to report and should be delegated to a principal security agent if there are many security agents 20 in a single domain.

Security agents may also share among each other high level information about what type of behavior is negatively impacting the cloud. Coordination of responses by the security agents 20 is described in more detail below.

Defense coordination messages represent the collective security agents performing a cloud-level action, whether it is starting or stopping a particular defense, such as application request rate-limiting or traffic redirection. The coordination mechanism is described in more detail below.

Configuration messages are sent by security agents to set the correct parameters for proper function. For example, security agents of a single domain may send each other messages to determine which security agent will be the principal agent and to coordinate what type of application request each agent will monitor. Also, security agents may send messages to configure the different sub-sections of a cloud.

Different security agents may coordinate the effort to detect the identities of users that send the most suspect requests, to cluster different suspect users, to evaluate the impact of each suspect user cluster, to define the rate limiting efforts directed toward different suspect users to bring back the virtual service domain load to an acceptable level, and/or to determine the most active clusters of suspect users to be eliminate to bring back the virtual service domain load to an acceptable level.

All the foregoing tasks may be performed in a collaborative way in all security agents, resulting in a coherent security policy to rate limit the same users, wherever they are. For example, this approach may detect the existence of suspect users launching attacks against a particular virtual service domain even if they alternate their target from one geographical zone to another.

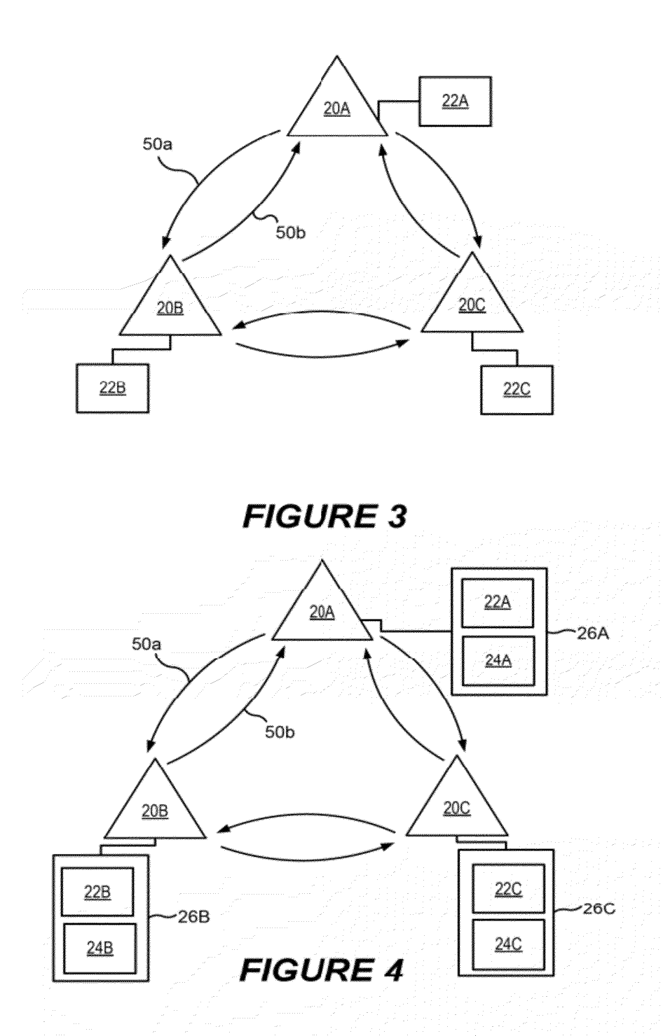

Referring to FIG. 3, three security agents 20A, 20B and 20C are illustrated. Each security agent monitors communications to/from one or more virtual hosts 62 within its assigned sub-section of a cloud and builds a data structure including information collected about the communications. In particular, the security agent 20A builds a data structure 22A, the security agent 20B builds a data structure 22B, and the security agent 20C builds a data structure 22C. According to some embodiments, each security agent 20A-20C then shares its data structure with the other security agents via informational messages 50a, 50b. Sharing of the data structures may occur at predetermined intervals, in response to a request from one or more security agents, in response to a predetermined event, in response to network traffic levels reaching a predetermined threshold, or for any other predetermined reason.

One or more of the security agents 20A-20C may then combine the data structures 22A-22C, resolving any inconsistencies in the data structures to form a master data structure. The master data structure may then be analyzed by one or more of the security agents 20A-20C to determine if a DDoS attack is occurring. If it is determined that such an attack is occurring, the security agents 20A-20C may exchange one or more defense coordination messages that may instruct the security agents to start or stop a particular defense, such as application request rate-limiting or traffic redirection. Accordingly, attacks may be detected using cloud-level information collected from multiple security agents, each of which may have awareness of only a part of the cloud.

In some embodiments, each security agent may collect different types of information that may be used to populate more than one data structure. As shown in FIG. 4, the security agents 20A-20C may store collected information in an associated data store 26A-26C in which first and second data structures 22A-22C and 24A-24C are provided. For example, the first data structures 22A-22C may store information relating to the number of requests received from particular clients, while the second data structures 24A-24C may be used to store information relating to the number of abnormal requests processed by virtual hosts within a particular sub-section of the cloud.

The first and second data structures 22A-22C and 24A-24C may be shared among the security agents 20A-20C at predetermined times as discussed above via informational messages 50a, 50b. It will be appreciated that the first data structures 22A-22C may be shared at the same or different times based on the same or different intervals or other triggering events as the second data structures 24A-24C.

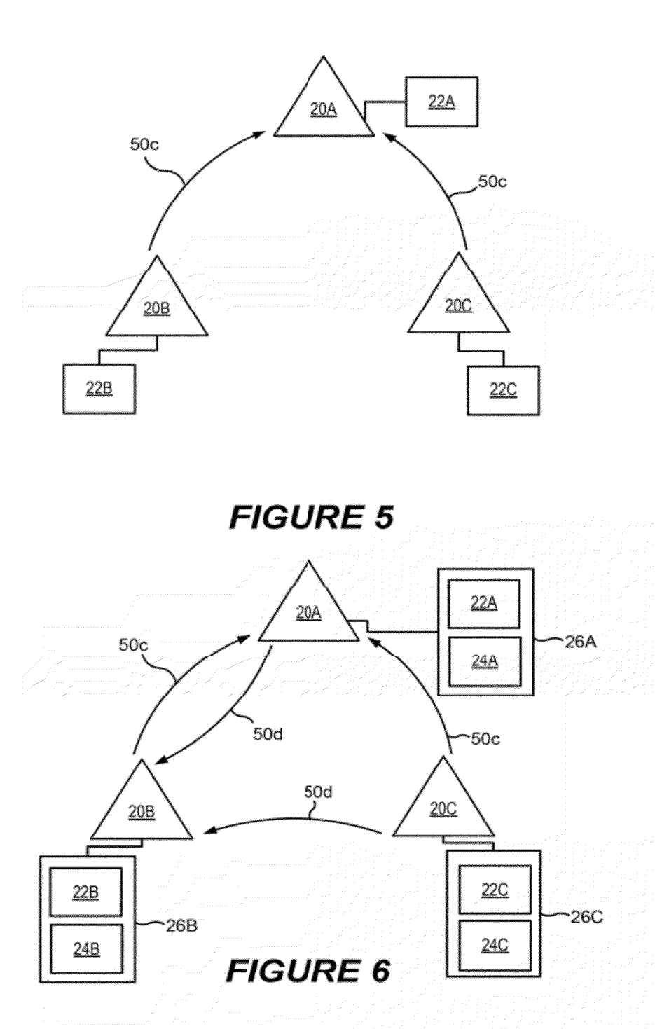

In some embodiments, one of the security agents 20A-20C may be designated to handle the harmonization and analysis of a particular type of data structure. In those embodiments, the data structure may not need to be sent to every security agent, but may be sent only to the designated security agent. For example, as shown in FIG. 5, the security agent 20A may be designated to manage the data structures 22A, 22B and 22C. Accordingly, the data structures 22B and 22C may be sent to the security agent 20A via informational messages 50c.

The security agent 20A may combine the data structures 22A-22C into a master data structure and analyze the master data structure for indications of a DDoS attack. If a DDoS attack is indicated, the security agent 20A may designate actions that can be taken by the security agents 20B and 20C to mitigate the attack.

Similarly, referring to FIG. 6, the security agent 20B may be designated to handle the harmonization and analysis of data structures 24A, 24B and 24C. Accordingly, the data structures 24A and 24C may be sent to the security agent 20B via informational messages 50d.

A coordination algorithm according to some embodiments is described below in connection with usage examples. In a first example, collaborative low-level bandwidth DDoS detection is performed.

To simplify the algorithm, the following example describes the application of the algorithm for only one VSD. It will be appreciated that several VSDs can run in different segments or in the same segment of the cloud. Thus, for each VSD, security agents may repeat the same behaviour.

First, one or more security agents in the cloud may monitor the VSD 64. Illegitimate or suspect requests that are sent to one or more virtual hosts 62 in the VSD may be detected. The illegitimate/suspect requests may be detected by the security agents though traffic inspection, e.g. DPI, and/or may be reported to a security agent from a virtual host. Each security agent may keep track of the rate of suspect requests for its virtual service domain (VSD) at any given time.

The security agents periodically exchange data structures containing or summarizing the collected information with one another. The frequency of this information exchange can be configured dynamically by the security agents. More frequent exchanges may result in the security agents having more accurate and up to date information, but may result in higher loads on the system.

Users sending suspect requests may be identified by the security agents, and their identities may be collected. For example, the addresses of users that send suspect requests may be logged and collected by one or more security agents. At each security agent, the identities, such as the network addresses, of different suspects then may be clustered. The clustering criteria can be the IP prefixes, type of request or any other suitable criteria.

Each security agent may cluster suspect addresses or other identities by sorting them into a tree of different nodes. The nodes of tree are connected through logical relations. For example, using four digit IPv4 addresses as the identities, a root node in the tree can be 10.2.*.*. The children nodes can be 10.2.1.* and 10.2.2.* and so on.

The total suspect requests are computed for each node. In this computation, a parent node may represent all its children nodes.

The security agents may exchange their respective trees. All trees may be merged into one tree representing different suspected traffic origins. This tree represents the suspect traffic requests in all segments of the cloud for the VSD.

Each security agent may exchange its local tree with other security agents. If there are inconsistencies in the trees, a voting algorithm or other decision mechanism may be used to decide the values for contentious nodes. At the end of this step, all security agents may have the same tree.

Each security agent then computes the amount of traffic which should be eliminated to allow the VSD to function normally within its segment. The amount of traffic to be considered as normal traffic is configurable. For example, it can be based on a service level agreement with clients or past traffic patterns for the customer. Note that a deterministic algorithm may be used, with the result that all security agents may choose the same nodes to be eliminated. This may result in consistent attack mitigation actions among the various segments.

Each security agent computes the minimum number of nodes which must be eliminated in order to bring the traffic to acceptable levels. To do this, the top nodes with highest suspect addresses may be rate limited (e.g., the amount of resources dedicated to responding to requests from such nodes may be reduced). This way, the users with highest rates of suspect requests are filtered, rather than users with low levels of suspect requests. In addition, suspected low rate attackers can be detected even though they attack different virtual hosts in different segments.

A security method according to some embodiments may adapt to attacks in a dynamic way across different segments in the cloud. The monitoring process may be performed through different centers, but the decision to rate limit may be made collaboratively by a number of security agents.

A second example involves a denial of service attack that is being launched on a particular service in a “follow-the-sun” approach. During the day, the majority of virtual resources are allocated to a cloud segment that serves a first geographic location (e.g., North America). As night falls, virtual resources are migrated to a cloud segment that serves a second geographic region located to the west of the first region (e.g., Asia). However, the attack continues on the service. Thus, there may be a clear advantage if the security agent in the first geographic region were to inform the security agent in the second geographic region to activate defenses pro-actively. This is preferable to suffering a temporary loss of service and reacting to a situation that is already known at the cloud level.

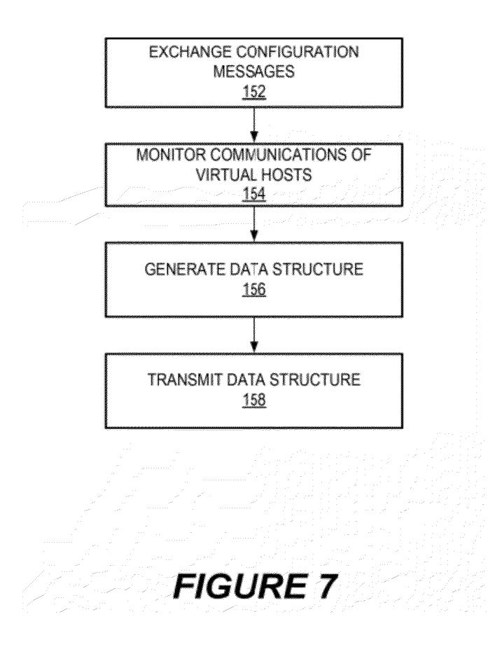

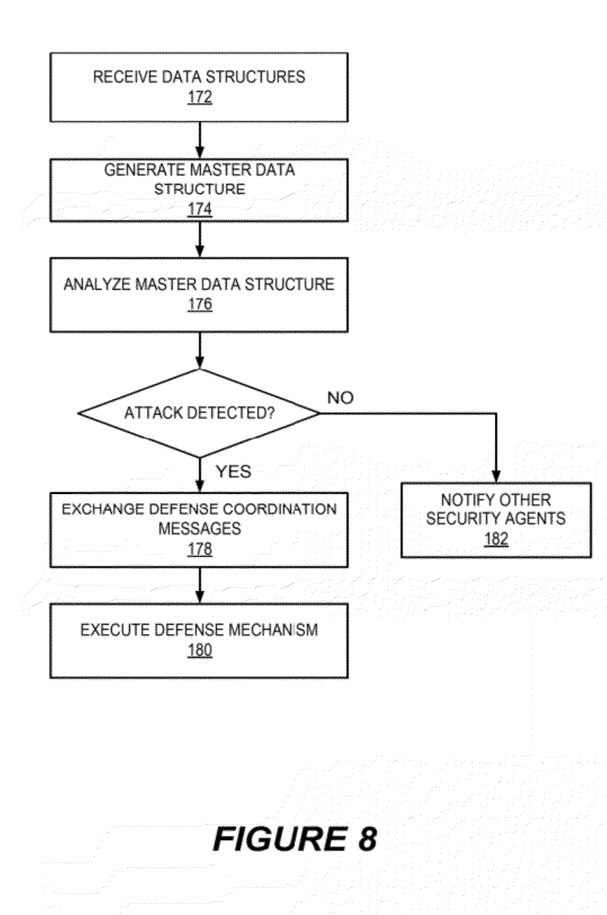

Operations according to some embodiments are illustrated in FIGS. 7 and 8. Referring to FIGS. 1, 2 and 7, a plurality of security agents 20 in a cloud 100 organize a defense against DDoS attacks by first exchanging configuration messages (Block 152). The configuration messages may be used to define the capabilities and/or responsibilities of particular security agents 20 in the cloud 100. For example, the configuration messages may allow the security agents to negotiate what aspects of communications will be monitored, what kinds of data structures will be generated, which security agent will collect and analyze particular types of data structures, etc.

Based on the agreed configuration parameters, the security agents 20 then monitor communications of the virtual hosts 62 within their assigned sub-sections of the cloud 100 (block 154). Based on the results of monitoring the communications, the security agents 20 construct a data structure (Block 156) and transmit the data structure to one or more specified security agents 20 (Block 158).

Referring to FIGS. 1, 2 and 8, a security agent 20 receives one or more data structures from other security agents 20 within the cloud 100 (Block 172). The security agent 20 combines the data structures to generate a master data structure (Block 174). In creating the master data structure, the security agent 20 may resolve inconsistencies and/or eliminate redundancies between various ones of the data structures. The security agent 20 then analyzes the master data structure in an attempt to identify the presence of a DDoS attack, if any (Block 176). For example, the security agent 20 may analyze the master data structure for evidence of a large number of illegitimate requests sent to multiple virtual hosts within a virtual service domain and/or within the cloud 100 generally.

If no attack is detected, the security agent 20 notifies the other security agents (Block 182).

If a DDoS attack is detected, the security agents may exchange defense coordination messages (Block 178). The defense coordination messages may allow the security agents to agree on a defense mechanism that will be used to counteract the DDoS mechanism, such as, for example, eliminating one or more nodes from a tree of nodes with which the virtual hosts are engaging in communications. Finally, the security agents execute the agreed defense mechanism (Block 180).

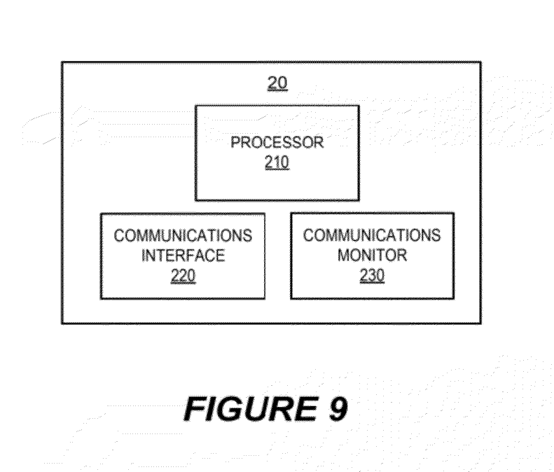

FIG. 9 is a block diagram of a security agent 20. As shown therein, the security agent 20 includes a processor 210, a communications interface 220 and a communications monitor 230. The processor may be a general purpose microprocessor. The communications interface 220 permits the security agent 20 to communicate with other security agents 20 in the cloud 100 as well as with virtual controllers 30. The communications monitor 230, which may be implemented as a module executed by the processor 210, permits the security agent 20 to monitor communications of one or more virtual hosts 62 within the cloud 100.

Embodiments of the present invention provide a framework that includes a set of virtual hosts serving a customer inside a cloud, includes a set of security agents in different segments of the cloud that monitor the virtual hosts (note that these servers can monitor more than one set of virtual hosts), and defines a distributed algorithm for controlling the interactions between these security agents to monitor and protect these virtual hosts. The behaviour of the security agents may be dynamically modified based on communications between the security agents.

An algorithm according to some embodiments may correlate information dynamically for all security agents in the cloud, and, accordingly, may be able to detect attacks which may not otherwise be detectable. Particular embodiments may decrease the Total Cost of Ownership of a cloud service by avoiding severe degradation of the cloud service, and/or creating the capability to mitigate many different kinds of DDoS attacks.

A cloud operator may therefore experience a reduced number of customer service requests regarding DDoS attacks, and cloud operators may be better able to offer and guarantee the terms of competitive Service Level Agreements.

A cloud operator employing a cloud-level DDoS defense according to some embodiments may automatically mitigate an attack before degradation of service occurs for all customers connected to a particular section of the cloud hosted in the affected physical data center.

Some embodiments may also serve as an extension to other security defenses. The distributed nature of a security defense according to embodiments of the invention can be applied specifically to DDoS, but can also be extended to other security methods, such as access control or Deep Packet Inspection applications, to provide awareness at the cloud level rather than only at individual nodes.

As will be appreciated by one of skill in the art, the present invention may be embodied as a method, data processing system, and/or computer program product. In particular, embodiments of the present invention may take the form of a computer program product on a tangible computer usable storage medium having computer program code embodied in the medium that can be executed by a computer. Any suitable tangible computer readable medium may be utilized including hard disks, CD ROMs, optical storage devices, magnetic storage devices, etc.

Some embodiments of the present invention are described herein with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java® or C++. However, the computer program code for carrying out operations of the present invention may also be written in conventional procedural programming languages, such as the “C” programming language. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method of managing network traffic in a distributed computing environment that provides virtual computing services to clients outside the distributed computing environment, the distributed computing environment including a plurality of physical resources, a plurality of network access points coupled to the plurality of physical resources by which clients can access the distributed computing environment, and a plurality of virtual hosts that are instantiated on the physical resources in the distributed computing environment and that are accessible by the clients through the plurality of network access points, the method comprising:
segmenting the plurality of virtual hosts into sub-groups of one or more virtual hosts;
providing a plurality of security agents within the distributed computing environment, wherein at least one of the plurality of security agents is associated with a respective sub-group of virtual hosts;
monitoring, at a first security agent of the plurality of security agents, first communications of virtual hosts within a first sub-group of virtual hosts associated with the first security agent;
monitoring, at a second security agent of the plurality of security agents, second communications of virtual hosts within a second sub-group of virtual hosts associated with the second security agent;
collecting information regarding the first communications and the second communications;
analyzing the collected information to detect a denial of service attack; and
in response to detecting the denial of service attack, initiating a defense mechanism to counteract the denial of service attack.

2. The method of claim 1, wherein monitoring communications of virtual hosts within the first and second sub-groups comprises monitoring at least one of number of service requests received from particular clients, number of abnormal requests received by virtual hosts, size of requests received by the virtual hosts, size of packets received by virtual hosts, frequency of requests received by virtual hosts, and bandwidth used by virtual hosts.

3. The method of claim 1, further comprising:
generating a first data structure at the first security agent in response to monitoring the first communications;
generating a second data structure at the second security agent in response to monitoring the second communications; and
combining the first and second data structures to form a combined data structure;
wherein analyzing the collected information to detect the denial of service attack comprises analyzing the combined data structure to detect the denial of service attack.

4. The method of claim 3, wherein combining the first and second data structures is performed by a designated one of the first or second security agents.

5. The method of claim 3, wherein combining the first and second data structures is performed by each of the first and second security agents.

6. The method of claim 3, wherein the combined data structure comprises a first combined data structure, and wherein monitoring the first and second communications comprises monitoring the first and second communications for a first communications characteristic, the method further comprising:
monitoring the first and second communications for a second communications characteristic that is different from the first communications characteristic;
generating a third data structure at the first security agent in response to monitoring the first communications for the second communications characteristic;
generating a fourth data structure at the second security agent in response to monitoring the second communications for the second communications characteristic;
combining the third and fourth data structures to form a second combined data structure; and
analyzing the second combined data structure to detect a second denial of service attack.

7. The method of claim 1, wherein initiating the defense mechanism comprises:
determining an amount of network traffic that should be reduced in order to reduce an impact of the denial of service attack on the distributed computing system;
identifying one or more nodes from a set of nodes with which the virtual hosts are communicating that can be eliminated to reduce network traffic by the determined amount; and
instructing the network access points to block traffic from the identified one or more nodes.

8. The method of claim 1, further comprising:
identifying a suspicious request to one or more virtual hosts within the first sub-group of virtual hosts; and
notifying the second security agent of the suspicious request in response to identifying the suspicious request.

9. The method of claim 1, further comprising:
identifying a plurality of suspicious requests to one or more virtual hosts within the sub-group of virtual hosts associated with the first one of the security agents;
processing identities of clients from which the plurality of suspicious requests originated to form a suspicious identity signature; and
transmitting the suspicious identity signature to the second security agent.

10. The method of claim 9, wherein the suspicious identity signature comprises a first suspicious identity signature, the method further comprising:
receiving a second suspicious identity signature from the second security agent;
comparing the first suspicious identity signature to the second suspicious address signature; and
resolving inconsistencies between the first suspicious identity signature and the second suspicious identity signature.

11. The method of claim 9, wherein processing the identities of clients from which the plurality of suspicious requests originated comprises clustering the identities.

12. The method of claim 9, wherein processing the identities of clients from which the plurality of suspicious requests originated comprises sorting the identities into a tree of nodes.

13. The method of claim 12, further comprising:
determining an amount of network traffic that should be reduced in order to reduce an impact of the denial of service attack on the distributed computing system;
identifying one or more nodes from the tree of nodes that can be eliminated to reduce the network traffic by the determined amount; and
instructing the network access points to block traffic from the identified one or more nodes from the tree of nodes.

14. The method of claim 1, wherein the plurality of hosts comprise a virtual service domain within the distributed computing environment.

15. A security agent, comprising:
a communications monitor configured to monitor communications of virtual hosts within an associated first sub-group of virtual hosts within a distributed computing environment; and
a processor configured to generate a first data structure in response to the monitored communications, to receive a second data structure from another security agent, the second data structure generated in response to monitoring second communications of virtual hosts within a second sub-group of virtual hosts, to combine the first and second data structures, and to analyze the combined data structures to detect a denial of service attack.

16. The security agent of claim 15, wherein the processor is further configured, in response to detecting the denial of service attack, to initiate a defense mechanism to counteract the denial of service attack.

17. The security agent of claim 15, wherein the communications monitor is configured to monitor first and second characteristics of communications of virtual hosts within the first sub-group of virtual hosts, and wherein the first data structure is generated in response to the first characteristics of the communications, and wherein the processor is further configured to generate a third data structure in response to the second characteristics of the communications.

18. The security agent of claim 15, wherein the processor is further configured to determine an amount of network traffic that should be reduced in order to reduce an impact of the denial of service attack on the distributed computing system, to identify one or more nodes from a set of nodes with which the virtual hosts are communicating that can be eliminated to reduce network traffic by the determined amount, and to instruct a network access point to block traffic from the identified one or more nodes.
